(19) United States
(12) Patent Application Publication
(10) Pub. No.: US 2011/0112947 A1
(43) Pub. Date: May 12, 2011

(54) Number for personal retirement

(76) Inventors: Jeffrey Theodore Liautaud, SR., Chicago, IL (US); Jeffrey Theodore Liautaud, JR., Chicago, IL (US)

(21) Appl. No.: 12/614,131

(22) Filed: Nov. 6, 2009

(51) Int. Cl. G06Q 40/00

(52) U.S. Cl. 705/35

(57) ABSTRACT

The object of the invention is to calcuate how much money may be spent per year from a retirement account over a client defined retirement period. The invention calculates a withdrawal amount or number or THE NUMBER FOR PERSONAL RETIREMENT. THE NUMBER is calculated from a complex formula using a hypothetical withdrawal amount compared to a remainer. When the absolute value of the remainder is less than the withdrawal amount, the withdrawal amount is correct within a range of answers. The range of answers is most accurate as the remainder diminishes to zero.

A distribution ratio may be calculated by dividing the withdrawal amount by the account starting value. Amazingly, when the distribution ratio is found for one account, the same distribution ratio is equally accurate for all other accounts of the client for a duration for example one year. A printed report by year proves THE NUMBER works.

### BRIEF SUMMARY OF THE INVENTION

The invention uses Chaos Theory to calculate how much money may come from a retirement nest egg. Chaos Theory has shown that many formulas have no solution. The appearance of formulas having a solution comes from books only selecting formulas with solutions. Chaos Theory deals with formulas that have no solutions and has deployed methods to approximate results that until now were hidden.

The invention is called THE NUMBER or the number for personal retirement. The object of the invention is to show how much money may be spent per year from a retirement account over a client defined retirement period. Using Chaos Theory in a preferred embodiment displayed on a monitor the invention compares two cells, with a first cell showing an initial estimation and a second cell showing the amount of money left over using a complex formula using the estimation and when the absolute value of the amount of money left is less than the withdrawal amount, the input means estimation for THE NUMBER is reasonably exact or correct or useful. In a preferred embodiment a computer automated estimating means provides the input means estimation that calculates THE NUMBER that results in an amount of money left over at or near zero. The input means estimation uses a simplified computing means to obtain the answer to a complex mathematical formula that otherwise may be too difficult or impossible to solve.

To overcome a practical problem of the estimation per instant changing in a subsequent instant, a preferred embodiment uses the estimation per instant for a duration for example for one year. Once THE NUMBER is calculated, a distribution ratio or withdrawal rate may be calculated for the duration.

Clients may have several investment accounts or piles. Amazingly when the distribution ratio is found for one pile, the same distribution ratio may be applied to all other piles of the client using the same assumptions. In a preferred embodiment the client states all assumptions used to calculate THE NUMBER.

### APPLICATION DETAILS

I have been looking for a simple way to show retirement (55) or financial independence (55) status. Here it is. It is called THE NUMBER (1) or the number for personal retirement (1) or hypothetical withdrawal amount (1) or withdrawal amount (1) or answer (1) or level amount withdrawn (1) or fluctuating amount withdrawn (1) or target (1) or moving target (1) or proposed retirement spending (1) from a pile of money (8) or an investment account (8) or a brokerage account (8) or pile (8) or nest egg (8) or supply of money (8). In a preferred embodiment THE NUMBER (1) is a level amount withdrawn plus inflation (21) or rate of inflation (21). However it may readily be seen that by adding any series of fluctuations (64) to THE NUMBER (1) may result in a fluctuating amount withdrawn (1). Unless specifically mentioned otherwise, THE NUMBER (1) is a level amount withdrawn plus inflation (21) or rate of inflation (21).

First I tried to write a formula (32) or complex formula (32) or complex mathematical formula (32) to determine the answer (1) but the formula (32) got too long. Even after only 4 years of a withdrawal period (12) or period (12) or retirement period (12) or expected period (12) or number “N” of years (12) or “N” years of retirement (55) the formula (32) contained about 30 terms (33). Each additional year of the period (12) about doubled the quantity of terms (33). THE NUMBER (1) or hypothetical withdrawal amount was a moving target (1) that never stayed stationary as instant upon instant passed. Since I needed to calculate what could be spent per year over a client defined retirement (55) period (12) for example 25 years I would need multitudinous terms (33). Even with a degree in Mathematics the formula (32) was near impossible to write.

Instead I built a computing means (24) or program (24) or calculator (24) or spread sheet (24) which is displayed on a computer (27) monitor (25) or monitor (25) for use with input means (26) or voice recognition input (26) or a keyboard (26) or computer (27) touch pad (26) and computed with a computer (27) or calculating device (27). Using input means (26) I provided an estimation (2) or accurate estimation (2) or realistic estimate (2) for THE NUMBER using computing means (24) with a complex formula (32).

Using Chaos Theory (82) in a preferred embodiment displayed on a monitor (25) I compare two cells (4), with a first cell (4) showing the input means (26) estimation (2) and a second cell (4) showing the amount of money left over (5) using the complex formula (32) and when the estimation (2) is less than the absolute value of the amount of money left over (5), the input means (26) estimation (2) for THE NUMBER (1) is reasonably exact (63) or correct (63) or useful (63). When the estimation (2) is less than the absolute value of the amount left over (5), less than one year's supply of money (8) remains in the amount left over (5). When during the retirement period (12) less than one year's supply of money (8) remains in the amount left over (5), the pile (8) has been reasonably used up. See Exhibit A.

A pretax (46) estimation (2) or an after tax (47) estimation (2) of THE NUMBER (1) may be used consistent with the invention. By pretax (46) is meant before state and federal income taxes. By after tax (47) is meant after state and federal income taxes. In a preferred embodiment a pretax (46) estimation (2) is used. In the preferred embodiment a rate of investment return (41) is a pretax rate of investment return (20).

In another preferred embodiment the input means (26) estimation (2) is entered by hand (85) thru a keyboard (26) until THE NUMBER is reasonably exact.

While I may use an estimation (2) by hand (85) on a spread sheet (24), it may readily be seen that a program (24) using written code (80) or a series of commands (80) from a commercially available software development platform (53) including but not limited to Visual Basic for Applications (53) or Active Server Pages (53) or VB.NET (53) or PHP (53) could readily be substituted for the spread sheet (24). A computer (27) automated estimating means (71) may also be substituted for an input means (26) estimation (2) for example by hand (85). In a preferred embodiment the computer (27) automated estimating means (71) uses an algorithm (72) or algorithms (72) or algorithm instructions (72). In another preferred embodiment the computer (27) automated estimating means (71) uses a macro (74) using written code (80) or a series of commands (80) that is recorded and assigned a keystroke (81) so that it can be played back at a later time.

Starting from an initial state, the algorithm instructions (72) describe a computation that proceeds through a well-defined series of successive states, eventually terminating in a final ending state where the withdrawal amount (1) is in a range between an upper limit (83) and a lower limit (84). The algorithm (72) compares the estimation (2) to an amount left over (5) in a range (78) that provides a withdrawal amount (1) that needs to be close but does not need to be exact (63) to be reasonably useful (76) or credible (76). In a preferred embodiment the credible (76) range occurs when the withdrawal amount (1) is less than the absolute value of the amount left over (5).

In another more refined preferred embodiment the withdrawal amount (5) is the last estimation (2) used by adding the integer 1 to the previous estimation (2) which results in an amount left over (5) equal to or greater than zero and a subsequent withdrawal amount (5) used by adding an integer 1 to the previous estimation (2) results in a negative amount left over (5). The more refined preferred embodiment typically results in an amount left over equal to zero to a given number of decimal places or the amount left over (5) is slightly greater than zero. See Exhibit A. For example if the amount of money left over (5) is above zero, the estimation (2) in the previous algorithm (72) is increased. If the amount of money left over (5) is below zero, the estimation (2) in the previous algorithm (72) is decreased. The answer (1) may be found when the algorithm (72) results in an amount left over of for example, zero to a given number of decimals, or to a range (78) between zero and a constant (73) whose value is greater than zero.

In another preferred embodiment, a macro (74) is used with a spread sheet (48). The spread sheet shows two cells (4), with a first cell (4) showing the input means (26) estimation (2) and juxtaposed to the first cell (4) a second cell (4) showing the amount of money left over (5) using the complex formula (32). By juxtaposing the first cell (4) next to the second cell (4) viewing results on a monitor (25) is easier. The macro (74) begins with an initial estimation (75) as the input means (26) estimation (2). If the amount of money left over (5) using the complex formula (32) is above zero, the macro (74) adds an integer (75) for example 1 to the input means (26) estimation (2) and keeps doing so until the amount of money left over (5) using the complex formula (32) diminishes towards zero for example, zero to a given number of decimal places, or to a range (78) between zero and a constant (73).

In a preferred embodiment, the macro (74) adds an integer greater than 1 for example 1,000, if the amount of money left over (5) using the complex formula (32) is above a constant (73) for example 100,000. Adding a number larger than 1 reduces computer (27) time. See Exhibit B for code used from a commercially available software development platform (53) in an Excel (16) version 1997-2002 macro (74) application and as an example of an algorithm that calculates THE NUMBER.

It has been shown that as the estimation (2) of the withdrawal amount (1) per year approximates an accurate estimation (2), an amount of money left over (5) diminishes to zero. As the amount of money left over (5) diminishes to zero, the estimation (2) approximates an accurate estimation (2) as of that instant (33) or point in time (33) or fixed point in time (33). The estimation (2) uses a simplified computing means (24) to obtain the answer (1) to the complex mathematical formula (32) that otherwise may be too difficult or impossible to solve.

To overcome a practical problem of the estimation (2) per instant (33) changing in a subsequent instant (34), a preferred embodiment uses the estimation (2) per instant (33) for a duration (35) or practical duration (35) or meaningfully useable duration (35) for example for one year. The estimation (2) may be reset at calendar year end or on the anniversary of the duration (35) for example a one year anniversary. While I have found that the one year duration (35) is a practical duration (35) or meaningfully useable duration (35), it may be readily seen that a duration (35) longer or shorter than one year may also be a practical duration (35).

THE NUMBER (1) needs to be close but does not need to be exact (63) to be reasonably useful (76) or credible (76). For example if the absolute value of the amount left over (5) is less than a level amount withdrawn (1) plus inflation (21) or rate of inflation (21) per year, THE NUMBER (1) will be credible. Likewise, if the amount left over (5) is low in relation to a pile of money (8) so as to reasonably cover the period (12), THE NUMBER (1) will be credible (76). For example, a client who is withdrawing over a period (12) having a larger number of years may have only a small change in THE NUMBER (1) from one year to the next, while a client who is withdrawing over a period (12) having a fewer number of years may have a larger change in THE NUMBER (1) from one year to the next. Changing the period (12) to bi annual or quarterly may be more appropriate for a client who is withdrawing over a period (12) having a fewer number of years.

Any spread sheet program (16) or spreadsheet (16) from a commercially available software development platform (53) such as Excel (16) or Lotus (16) will work to obtain the estimation (2). The amount of money left over (5) is displayed on the monitor (25) in a spread sheet (24) cell (4) set up for the purpose. When the amount of money left over (5) approximates zero that's the answer (1). The answer (1) is a level amount withdrawn (1) plus inflation (21) or rate of inflation (21) for a period (12) or number “N” of years (12).

The level amount withdrawn (1) plus inflation (21) or rate of inflation (21) comes from a pile of money (8). The client can prove that the level amount withdrawn (1) plus inflation (21) or rate of inflation (21) works by looking at a printed calculation page (6) or printed sheet (6) which shows year by year a start amount (7) of the pile (8), plus an earned amount (9) or investment returns (9) at a rate of investment return (41), less the level amount withdrawn (1) plus inflation (21) or rate of inflation (21), equal to an end amount (11) of the pile (8). See Exhibit A.

Earned amount (9) equals rate of investment return times the pile (8). The formula (32) for each year is this: the pile (8) plus earned amount (9) less the level amount withdrawn (1) plus inflation (21) or rate of inflation (21) equals the end amount (11) of the pile (8); the following year the end amount (11) from the previous year becomes the start amount (7) for the next year, and so forth for each year of the retirement period (12) or number “N” of years (12) all of which taken together may be called an iteration (38) or calculations (38).

In another preferred embodiment I list each year, 1, 2, 3, and so forth for “N” (12) years on a spread sheet row (49) in a spread sheet column (48) so that the end amount (11) of the pile (8) may be calculated in a summation column (50) based on a condition (54) that occurs when the last of “N” (12) of years has been obtained. The sum of the values in the summation column (50) becomes the amount of money left over (5). By entering several estimations (2), when an accurate estimation (2) is found, the amount of money left over (5) approximates zero and the accurate estimation (2) becomes THE NUMBER (1).

Thus finding an answer (1) to a complex mathematical formula (32) is replaced by an iteration (38) that occurs when the absolute value of the amount of money left over (5) is less than the level amount withdrawn (1) plus inflation (21) or rate of inflation (21). The answer may be proven by any party by displaying calculations (38) for each year of the retirement period (12) for example on a printed sheet (6). See Exhibit A.

At the end of N years (12) the pile (8) is gone, which proves that THE NUMBER (1) works for practical purposes. No one need know how THE NUMBER (1) was obtained to know that THE NUMBER (1) works for practical purposes.

In a preferred embodiment using a spreadsheet (16) or a macro (74) or an algorithm (72), the initial estimation (75) may be obtained by an initial estimation formula (79) equal to an initial estimation (75) a little greater than the pile (8) times pretax rate of investment return (20) less inflation (21). Since the pile (8) would not change without pretax rate of investment return (20) less inflation (21), the initial estimation formula (79) may be significantly greater than 1. By using an initial estimation (75) greater than 1, computer (27) time is saved and efficiency increases.

Once THE NUMBER is calculated, a distribution ratio (18) or ratio (18) or withdrawal rate (18) may be calculated for the duration (35) or practical duration (35) or meaningfully useable duration (35) for example for one year. The distribution ratio (18) is obtained by dividing THE NUMBER (1) by the first pile (8) under consideration. Using the distribution ratio (18) saves a lot of work during the duration (35) because only one calculation taking only minutes is necessary per duration (35). An investment report (3) or statement (3) or report (3) or proof page (3) may be generated during the duration (35) without changing the distribution ratio (18).

In a preferred embodiment the distribution ratio (18) is calculated on a separate page of the investment report (3). Once obtained the ratio (18) may be displayed on the monitor, copied, pasted formulas as values into another page of the spread sheet (16) as a continuing distribution ratio (18) during the duration (35). Thus the pile (8) may change, but the ratio (18) need not change until the anniversary of the duration (35). Even as the pile (8) fluctuates, multiplying the distribution ratio (18) times the pile (8) may yield a realistic estimate (2) for THE NUMBER (1) during the duration (35).

Clients may have several investment accounts (8) or piles (8). Amazingly when the distribution ratio (18) is found for one pile (8), the same distribution ratio (18) may be applied to all other piles (8) of the client using the same assumptions (42) or client states all assumptions (42) or client stated assumptions (42). Subsequent calculations (38) prove that using the same distribution ratio (18) for all piles (8) of the client using the same assumptions works because at the end of the period (12) all piles (8) are gone.

THE NUMBER (1) is a hypothetical amount that may be spent per year for the period (12) or number of “N” of years (12) or “N” years (12). Using the distribution ratio (18) during the duration (35) is beneficial to the client. If a client is not yet withdrawing, the client can see THE NUMBER (1) change throughout the duration (35) based solely on changes to the pile (8) and from this may deduce proposed retirement spending (1) per year for “N” years (12) during retirement (55). Seeing proposed retirement spending (1) per year is important whether the client is making an actual withdrawal (39) or taking an actual withdrawal amount (39) or not because during the duration (35) the client may add savings (16) to an investment account plus obtain investment returns (9) and see THE NUMBER (1) increase (or decrease) during the duration (35) as his pile (8) increases (or decreases). This may make proposed retirement spending (1) more realistic and increase client motivation to save.

THE NUMBER (1) makes retirement more real. If the client is making an actual withdrawal (39) in retirement (55) or at financial independence (55), the client may compare the actual withdrawal amount (39) to THE NUMBER (1). Thus the client is empowered to sync up the actual withdrawal (39) to THE NUMBER (1). This may prevent running out of a nest egg (8) before “N” years (12) or may prevent an unintended pile (8) at the end of “N” years (12).

It is common practice for advisors to recommend a withdrawal rate (18). As has been shown a preferred embodiment is to calculate the withdrawal rate (18) or distribution ratio (18). Without knowing how to calculate the distribution ratio (18), the distribution ratio (18) may be chosen arbitrarily. If an advisor (67) or broker (67) or broker dealer (67) or financial consultant (67) or wealth manager (67) or fiduciary (67) stated withdrawal rate (18) is arbitrarily chosen, the stated withdrawal rate (18) may be too high and the client may run out of money too soon. Using an arbitrary withdrawal rate (18) may result in use of a more conservative withdrawal rate (18). If an advisor (67) stated withdrawal rate (18) is too low, the client's standard of living may be compromised. If the client states all assumptions (42) or using client stated assumptions (42) to calculate a withdrawal rate (18) may put the client in control instead of the advisor (67).

In the preferred embodiment the client states all assumptions (42) used in the estimation (2) including pretax rate of investment return (20), rate of inflation (21) or inflation (21), and the period (12) of retirement (55). The withdrawal amount (1) may be expressed with inflation (21) or without inflation (21). If the withdrawal amount (1) is expressed without inflation (21), the withdrawal amount (1) will be a level amount withdrawn (1) plus inflation (21) or rate of inflation (21) each year for “N” years (12) until the nest egg (8) is gone. If the withdrawal amount (1) includes inflation (21), it will be the level amount withdrawn (1) increased by inflation (21) each year.

In a preferred embodiment THE NUMBER (1) is a level amount withdrawn (1) plus inflation (21) or rate of inflation (21). However it may readily be seen that adding a series of fluctuations (64) to a level amount withdrawn (1) plus inflation (21) or rate of inflation (21) would obtain a fluctuating amount withdrawn (1) plus inflation (21) or rate of inflation (21). Any series of fluctuations (64) may be superimposed on the complex mathematical formula (32) comparing the input means (26) estimation to the complex formula (32) accurate estimation (2) to get THE NUMBER correct (1). Any comparison (43) may be a direct comparison (68) if a fluctuating amount withdrawn (1) is compared to for example fluctuating client stated assumptions (69), or if a level amount withdrawn is compared to for example level client stated assumptions (70). Realism increases with a direct comparison (43).

In a preferred embodiment, the client is empowered with greater control over a realistic estimate (2) of proposed retirement spending (1) when the client states all assumptions (37) used in the estimation of THE NUMBER (1). The realism comes from a direct comparison (68) of client stated assumptions (37) to actual results (44). For example, in a direct comparison to a level amount withdrawn (1) plus inflation (21) or rate of inflation (21) rate of investment return (41) as a client stated assumption (42) may be compared to actual rate of investment return (45). Likewise, inflation (21) or rate of inflation (21) as a client stated assumption (42) may be compared to actual rate of inflation (77). Thus revisions (46) or a revision (46) to client stated assumptions (43) may be made by the client as needed.

Another important comparison (43) may be comparing actual rate of investment return (45) to an expected long term rate of investment return (59). It is commonly held that the total US stock market has given off a return of 10.5% including inflation (21) over a very long period of time. In a preferred embodiment an expected long term rate of investment return (59) may be established for a risk tolerance (56) or a given risk tolerance (56) such as conservative, moderate, aggressive, or a combination such as moderate aggressive.

It is common practice for advisors (67) to establish for each client a risk tolerance (56). In the preferred embodiment an expected long term rate of investment return (59) may be established for each risk tolerance. The Dow Jones US Total Market Index is meant to measure performance of the US stock market as a whole. In the preferred embodiment a benchmark (57) such as Dow Jones US Total Market Index Fund (symbol IYY) is established for each client based on risk tolerance and expressed as a multiplier (58) of IYY. In a preferred embodiment, the risk tolerance adjustments are conservative (IYY×0.57), moderate (IYY×0.71), aggressive (IYY×1), or moderate aggressive (IYY×0.86). Different multipliers (58) are used because for example a person who is conservative cannot expect to make as great a rate of investment return (41) as a person who is aggressive.

By applying the multiplier (58) for each given risk tolerance (56), an expected long term rate of investment return (59) may be established for that risk tolerance (56). For example an aggressive risk tolerance person would use a multiplier of 100% times 10.5%, which may yield a long term benchmark (60) of 10.5%, a moderate aggressive risk tolerance person would use a multiplier of 86% times 10.5%, which may yield a long term benchmark (60) of 9%, a moderate risk tolerance person would use a multiplier of 71% times 10.5%, which may yield a long term benchmark (60) of 7.5%, and a conservative risk tolerance person would use a multiplier of 57% times 10.5%, which may yield a long term benchmark (60) of 6.0%.

It has already been noted that it is common practice for advisors (67) to establish for each client a distribution ratio (18). According to Investment News on Oct. 11, 2009, 90% of advisors (67) use distribution ratios (18) that range from 3% to 6%. Actual investment returns (9) limit distribution ratios (18).

In a preferred embodiment excess returns (61) are defined as gains (62) over the benchmark (57). Beating the benchmark (57) is a significant way that the client can measure an advisor (67). An advisor (67) recommended low withdrawal rate (18) may mask substandard actual rate of investment returns (45). The risk to the client of a substandard actual rate of investment returns (45) is a reduced standard of living in retirement (55).

The significance of excess returns (61) is that over a long period of time cumulative excess returns (61) may help to protect the client from returns that fall below benchmark (57) in any given year. The more cumulative excess returns (61), the less likely that single incidences of returns below benchmark (57) may drag down actual rate of investment return (45) to the long term benchmark (60). Stated another way if cumulative excess returns (61) exist then the long term benchmark (60) may be more likely to be the expected long term rate of investment return (59) or better.

In a preferred embodiment, the client may make revisions (37) to expected long term rate of investment return (59). For example, rate of investment return (41) as a client stated assumption (43) may be compared to actual rate of investment return (45). In the preferred embodiment, both THE NUMBER is expressed as a compound return (65) and the actual rate of investment return (45) is expressed as a compound return (65) so a direct comparison (68) may be made.

Thru revisions (46) to any client stated assumptions (43) the client may get ever closer to an accurate estimation (2) of THE NUMBER (1). The client may adjust expected long term rate of investment return (59) based on advisor (67) excess returns (61) or a lack thereof. Revisions (46) to client stated assumptions (43) may increase in clarity over time. An accurate estimation (2) of THE NUMBER is essential (1) prior to retirement and during the period (12) of retirement. Thru revisions (46) during the period (12) of retirement (55) accuracy of THE NUMBER (2) improves with client experience and fiduciary advice (66) which puts the needs of the client ahead of the needs of the advisor (67).

| Exhibit A-Proof Page | | | | | |
|---|---|---|---|---|---|
| Paten Sample Family | | | | | |
| THE NUMBER | | For Period Ended | | Nov. 08, 2009 | |
| 3,696 | | | | “You Have” | |
| F080: ExhibitA | | | | | |
| | | | inflation | Amount | |
| | 26 | 8% | 3.50% | $56,899 | Left Over |
| | | investment | less paid | | |
| year | start | return | per year | end | 2 |
| 1 | 56,899 | 4,552 | (3,826) | 57,626 | |
| 2 | 57,626 | 4,610 | (3,959) | 58,276 | |
| 3 | 58,276 | 4,662 | (4,098) | 58,840 | |
| 4 | 58,840 | 4,707 | (4,241) | 59,306 | |
| 5 | 59,306 | 4,744 | (4,390) | 59,661 | |
| 6 | 59,661 | 4,773 | (4,544) | 59,890 | |
| 7 | 59,890 | 4,791 | (4,703) | 59,979 | |
| 8 | 59,979 | 4,798 | (4,867) | 59,910 | |
| 9 | 59,910 | 4,793 | (5,038) | 59,665 | |
| 10 | 59,665 | 4,773 | (5,214) | 59,224 | |
| 11 | 59,224 | 4,738 | (5,396) | 58,566 | |
| 12 | 58,566 | 4,685 | (5,585) | 57,666 | |
| 13 | 57,666 | 4,613 | (5,781) | 56,499 | |
| 14 | 56,499 | 4,520 | (5,983) | 55,035 | |
| 15 | 55,035 | 4,403 | (6,192) | 53,246 | |
| 16 | 53,246 | 4,260 | (6,409) | 51,096 | |
| 17 | 51,096 | 4,088 | (6,633) | 48,551 | |
| 18 | 48,551 | 3,884 | (6,866) | 45,569 | |
| 19 | 45,569 | 3,646 | (7,106) | 42,109 | |
| 20 | 42,109 | 3,369 | (7,355) | 38,123 | |
| 21 | 38,123 | 3,050 | (7,612) | 33,560 | |
| 22 | 33,560 | 2,685 | (7,878) | 28,367 | |
| 23 | 28,367 | 2,269 | (8,154) | 22,482 | |
| 24 | 22,482 | 1,799 | (8,440) | 15,841 | |
| 25 | 15,841 | 1,267 | (8,735) | 8,373 | |
| 26 | 8,373 | 670 | (9,041) | 2 | 2 |

Exhibit B-Macro Code and Algorithm Example

```
This is an example of code used from a commercially available software development platform
(53) in an Excel (16) version 1997-2002 macro (74) application and as an example of an
algorithm that calculates THE NUMBER.
Sub CalcPmtPerYear( )
  ′
  ′ CalcPmtPerYear Macro
  ′
  ′ Keyboard Shortcut: Ctrl+Shift+A
  Dim lngStartValue As Long
  Dim lngEndValue As Long
  Dim lngTestValue As Long ′this is what we'll try until we see the first negative number in cell
T6
  ′first clear out the paid/yr value since this is what we will be calculating
  Range(“S6”).Value = 0
  ′grab value to use as starting point in Cell T4 which contains
  ′the formula to calculate our starting value (pile[P6] * (inv return[P4] − inflation[P5]))
  lngStartValue = CLng(Range(“T4”).Value)
  ′start loop incrementing value by 1 each iteration until we see
  ′the first negative number in cell T6
  Do
    ′reset the test and end values
    lngTestValue = 0
    lngEndValue = 0
    ′write start value to cell S6
    Range(“S6”).Value = lngStartValue
    ′set the end value (just in case we are, in fact, at the end
    lngEndValue = lngStartValue
    ′read value from cell T6 now that we've written to cell S6
    lngTestValue = CLng(Range(“T6”).Value)
    ′increment start value by 1
    If lngTestValue > 100000 Then
      lngStartValue = lngStartValue + 1000
    Else
      lngStartValue = lngStartValue + 1
    End If
```

I claim:

1. A computerized system for combining a complex formula for calculating a withdrawal amount from a pile amount over a period of time with an automated estimation of the withdrawal amount, the system comprising:
a. a first program configured to obtain a projected remainder of the pile amount at the end of the period;
b. a second program configured to estimate the withdrawal amount by comparing the projected remainder to more than one hypothetical withdrawal amount until substantially the absolute value of the remainder is less than the withdrawal amount; and
c. substantially depleting the pile amount at the end of the period.

2. A computerized system for combining a complex formula for calculating a withdrawal amount from a pile amount over a period of time with an automated estimation of the withdrawal amount, the system comprising:
a. a first program configured to apply the complex formula during the period including:
i. adding a value to the pile amount based on a rate of return,
ii. subtracting from the pile amount a hypothetical withdrawal amount,
iii. projecting a remainder for the pile amount at the end of the period;
b. a second program configured to estimate the withdrawal amount by comparing the projected remainder to more than one hypothetical withdrawal amount until substantially the absolute value of the remainder is less than the withdrawal amount; and
c. substantially depleting the pile amount at the end of the period.

3. The system of claim 1 further comprising an initial estimation formula included in the second program.

4. The system of claim 1 displaying an actual withdrawal amount with the automated estimation of the withdrawal amount.

5. The system of claim 2 further including in the second program an input means for manually estimating the withdrawal amount including two cells with a first cell displaying the projected remainder and a second cell displaying the withdrawal amount.

6. A computerized method for combining a complex formula for calculating a withdrawal amount from a pile amount over a period of time with an automated estimation of the withdrawal amount, the method comprising:
a. obtaining from the pile amount a projected remainder of the pile amount at the end of the period;
b. estimating the withdrawal amount by comparing the projected remainder to more than one hypothetical withdrawal amount until substantially the absolute value of the remainder is less than the withdrawal amount; and
c. substantially depleting the pile amount at the end of the period.

7. A computerized method for combining a complex formula for calculating a withdrawal amount from a pile amount over a period of time with an automated estimation of the withdrawal amount, the method comprising:
a. applying the complex formula during the period including:
i. adding a value to the pile amount based on a rate of return,
ii. subtracting from the pile amount a hypothetical withdrawal amount,
iii. projecting a remainder for the pile amount at the end of the period;
b. estimating the withdrawal amount by comparing the projected remainder to more than one hypothetical withdrawal amount until substantially the absolute value of the remainder is less than the withdrawal amount; and
c. substantially depleting the pile amount at the end of the period.

8. A client determined distribution ratio for a retirement pile amount during a client stated retirement period, including a computerized method for calculating the distribution ratio, the method comprising:
a. applying a complex formula during the period including:
i. adding a value to the pile amount based on a client stated rate of return,
ii. subtracting from the pile amount a hypothetical withdrawal amount,
iii. projecting a remainder for the pile amount at the end of the period;
b. estimating a withdrawal amount by comparing the projected remainder to more than one hypothetical withdrawal amount until substantially the absolute value of the remainder is less than the withdrawal amount;
c. substantially depleting the pile amount at the end of the period;
d. calculating the distribution ratio by dividing the withdrawal amount by the pile amount starting value; and
b. displaying a proof display for proving the hypothetical withdrawal amount is credible.

9. The method of claim 6 further comprising displaying the withdrawal amount.

10. The method of claim 6 further comprising estimating the hypothetical withdrawal amount including an initial estimation formula.

11. The method of claim 6 further comprising estimating the withdrawal amount including an algorithm.

12. The method of claim 6 further comprising estimating the withdrawal amount including a macro.

13. The method of claim 6 further comprising estimating the withdrawal amount including a spreadsheet.

14. The system of claim 1 further comprising a network operatively coupled with the computerized system.

15. The method of claim 6 further comprising displaying a proof display for proving the withdrawal amount is credible.

16. The system of claim 1 operatively connected with an internet address.

17. A method for combining a complex formula on a calculator for calculating a withdrawal amount from a pile amount over a period of time with an automated estimation of the withdrawal amount, the system comprising:
a. obtaining from the pile amount a projected remainder of the pile amount at the end of the period;
b. estimating the withdrawal amount by comparing the projected remainder to more than one hypothetical withdrawal amount until substantially the absolute value of the remainder is less than the withdrawal amount;
c. substantially depleting the pile amount at the end of the period and
d. displaying the withdrawal amount.

18. The system of claim 1 with the first program further including a spreadsheet and the second program further including a macro.

19. The system of claim 1 with the withdrawal amount further including a range of numbers between zero and a constant.

20. The system of claim 1 further including a proof display for proving the withdrawal amount is credible.

21. The method of claim 6 with the complex formula further including client stated assumptions.

22. A system for combining a complex formula on a calculator for calculating a withdrawal amount from a pile amount over a period of time with an automated estimation of the withdrawal amount, the system comprising
a. a first program configured to obtain a projected remainder of the pile amount at the end of the period;
b. a second program configured to estimate the withdrawal amount by comparing the projected remainder to more than one hypothetical withdrawal amount until substantially the absolute value of the remainder is less than the withdrawal amount;
c. substantially depleting the pile amount at the end of the period; and
d. displaying the withdrawal amount.

23. The system of claim 1 with the complex formula further including client stated assumptions.

24. The method of claim 6 further comprising a network operatively coupled with the computerized system.

25. A client determined distribution ratio for a retirement pile amount during a client stated retirement period, including a computerized system for calculating the distribution ratio, the system comprising:
a. a first program configured to apply a complex formula during the period including:
i. adding a value to the pile amount based on a client stated rate of return,
ii. subtracting from the pile amount a hypothetical withdrawal amount,
iii. projecting a remainder for the pile amount at the end of the period;
b. a second program configured to estimate the withdrawal amount by comparing the projected remainder to more than one hypothetical withdrawal amount until substantially the absolute value of the remainder is less than the withdrawal amount;
c. substantially depleting the pile amount at the end of the period;
e. calculating the distribution ratio by dividing the withdrawal amount by the pile amount starting value; and
b. displaying a proof display for proving the hypothetical withdrawal amount is credible.

26. The system of claim 25 further including multiplying the distribution ratio by more than one retirement pile amount per duration.

27. The method of claim 7 estimating the withdrawal amount further including an input means for manually estimating the withdrawal amount including a first cell displaying the projected remainder, and a second cell displaying the withdrawal amount.

28. The system of claim 1 further including comparing the remainder to zero.

29. The method of claim 6 calculating the distribution ratio by dividing the withdrawal amount by the pile amount starting value less frequently in a duration than calculating the withdrawal amount.

30. The method of claim 6 further including comparing the remainder to zero.

31. The method of claim 1 calculating the distribution ratio on a separate page of a spreadsheet from a page displaying THE NUMBER.

32. A computerized method for calculating an estimation of a withdrawal amount from a pile amount over a period of time, the method comprising:
a. applying a complex formula during the period including
i. adding a value to the pile amount based on a client stated rate of return,
ii. subtracting from the pile amount a hypothetical withdrawal amount,
iii. projecting a remainder for the pile amount at the end of the period;
b. estimating the withdrawal amount by comparing the projected remainder to more than one hypothetical withdrawal amount until substantially the absolute value of the remainder is less than the withdrawal amount; and
c. substantially depleting the pile amount at the end of the period.

33. The system of claim 1 further comprising estimating the withdrawal amount including a spreadsheet.

34. A computerized system for calculating an estimation of a withdrawal amount from a pile amount over a period of time, the system comprising:
a. a first program configured to obtain a projected remainder of the pile amount including:
i. adding a value to the pile amount based on a rate of return,
ii. subtracting from the pile amount a hypothetical withdrawal amount,
iii. projecting a remainder for the pile amount at the end of the period;
b. a second program configured to estimate the withdrawal amount by comparing the projected remainder to more than one hypothetical withdrawal amount until substantially the absolute value of the remainder is less than the withdrawal amount; and
c. substantially depleting the pile amount at the end of the period.

35. The method of claim 6 displaying an actual withdrawal with the automated estimation of the withdrawal amount.
